(19) United States
(12) Patent Application Publication
(10) Pub. No.: US 2010/0276294 A1
(43) Pub. Date: Nov. 4, 2010

(54) ELECTROLYTIC SANITIZATION OF WATER

(76) Inventor: John M. Lambie, Portland, OR (US)

Correspondence Address: ALLEMAN HALL MCCOY RUSSELL & TUTTLE LLP, 806 SW BROADWAY, SUITE 600, PORTLAND, OR, 97205-3335, US

(21) Appl. No.: 12/787,060

(22) Filed: May 25, 2010

Related U.S. Application Data
(63) Continuation-in-part of application No. 11/644,647, filed on Dec. 22, 2006, now abandoned.
Application No. 11/644,647 is a continuation of application No. 10/853,027, filed on May 21, 2004, now abandoned.
Application No. 11/644,647 is a continuation of application No. 10/815,174, filed on Mar. 26, 2004, now abandoned.
(60) Provisional application No. 60/473,245, filed on May 23, 2003.
(60) Provisional application No. 60/458,313, filed on Mar. 28, 2003.

(51) Int. Cl. C02F 1/467; C25B 9/00

(52) U.S. Cl. 205/335; 204/228.6

(57) ABSTRACT

A method for sanitizing water comprises flowing the water without added electrolyte between opposing first and second electrodes arranged in an electrolysis cell, the water forming a continuous flow that contacts both electrodes simultaneously before exiting the electrolysis cell. The method further comprises biasing the first and second electrodes with respect to each other in response to a relative amount of a bioinhibitory agent in the water exiting the electrolysis cell.

### CROSS REFERENCE TO RELATED APPLICATIONS

This application is a continuation-in-part of U.S. patent application Ser. No. 11/644,647, filed Dec. 22, 2006 and entitled “Method for Electrolytic Disinfection of Water.” U.S. patent application Ser. No. 11/644,647 is a continuation of U.S. patent application Ser. No. 10/853,027, filed May 21, 2004 and entitled “Method for Electrolytic Disinfection of Water”, which claims priority to U.S. Provisional Patent Application Ser. No. 60/473,245, filed May 23, 2003 and entitled “Method for Electrolytic Disinfection of Water”; and also a continuation of U.S. patent application Ser. No. 10/815,174, filed Mar. 26, 2004 and entitled “Method and Apparatus for Removing and Controlling Microbial Contamination in Dental Unit Water Lines By Electrolysis”, which claims priority to U.S. Provisional Patent Application Ser. No. 60/458,313, filed Mar. 28, 2003 and entitled “Method and Apparatus for Removing and Controlling Microbial Contamination in Dental Unit Water Lines By Electrolysis”. The entirety of each of these applications is hereby incorporated by reference herein for all purposes.

### TECHNICAL FIELD

This application relates to the field of water sanitization, and more particularly, to the use of electrolysis in water sanitization.

### BACKGROUND

Motivated by the tragic, widespread problem of water-borne illness, numerous technologies have emerged for controlling microbial flora in drinking water. Some such technologies are based on electrochemical generation of chlorine—a potent biocidal agent. In U.S. Patent Application Publication 2002/0020675, for example, a salt-brine solution is passed between two biased electrodes to yield a chlorine-containing inoculant solution. The inoculant solution is used to treat potentially impotable water to make it potable.

The inventor herein has identified several deficiencies, however, of the approach cited above. First, a ready supply of salt brine is needed, which may not be practical at every location where water treatment is desired. Second, the very act of inoculating the water with an electrolytic solution will increase the concentration of total dissolved solids (TDS) in the water, which may be objectionable. Third, the cited approach relies entirely on the action of chlorine and related species as biocidal agents; it neglects the possibility that other species derived from water electrolysis may have desirable bioinhibitory properties.

### SUMMARY

Therefore, one embodiment of this disclosure provides a method for sanitizing water. The method comprises flowing the water without added electrolyte between opposing first and second electrodes arranged in an electrolysis cell, the water forming a continuous flow that contacts both electrodes simultaneously before exiting the electrolysis cell. The method further comprises biasing the first and second electrodes with respect to each other in response to a relative amount of a bioinhibitory agent in the water exiting the electrolysis cell.

It will be understood that the summary above is provided to introduce in simplified form a selection of concepts that are further described in the detailed description, which follows. It is not meant to identify key or essential features of the claimed subject matter, the scope of which is defined by the claims that follow the detailed description. Further, the claimed subject matter is not limited to implementations that solve any disadvantages noted herein.

### BRIEF DESCRIPTION OF THE DRAWINGS

FIG. 1 schematically shows an example water-treatment system in accordance with an embodiment of this disclosure.

FIG. 2 schematically shows an example electrolysis cell and flow chamber of a water-treatment system in accordance with an embodiment of this disclosure.

FIGS. 3 and 4 illustrate example methods for sanitizing water in accordance with embodiments of this disclosure.

### DETAILED DESCRIPTION

The subject matter of this disclosure is now described by way of example and with reference to certain illustrated embodiments. Components, process steps, and other elements that may be substantially the same in one or more embodiments are identified coordinately and are described with minimal repetition. It will be noted, however, that elements identified coordinately may also differ to some degree. It will be further noted that the drawing figures included in this disclosure are schematic and generally not drawn to scale. Rather, the various drawing scales, aspect ratios, and numbers of components shown in the figures may be purposely distorted to make certain features or relationships easier to see.

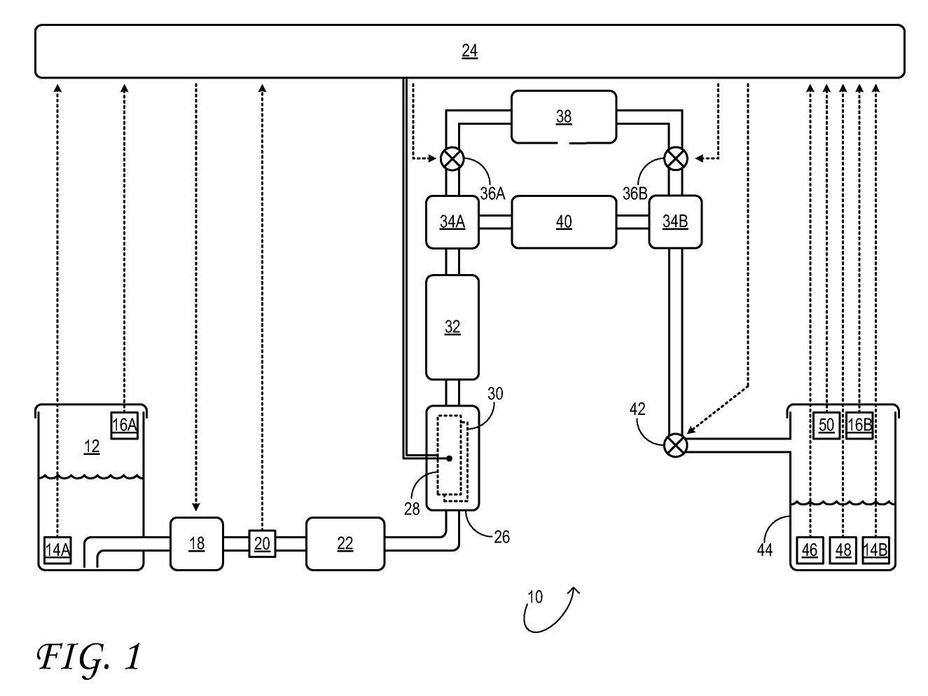

FIG. 1 schematically shows, in one embodiment, an example water-treatment system 10 for sanitizing water. The water-treatment system includes holding tank 12, in which potentially impotable water may be stored for later sanitization. The holding tank includes low-level sensor 14A and high-level sensor 16A. These sensors are configured to sense whether the water in the holding tank is below or above certain desired threshold levels.

Water-treatment system 10 includes pump 18. The pump is configured to draw water from holding tank 12 and to pump the water to downstream components of the water-treatment system. To monitor the rate at which the water is flowing through the water-treatment system, flow-rate sensor 20 is coupled downstream of the pump.

Water-treatment system 10 includes pretreatment stage 22 coupled downstream of the flow-rate sensor. The pretreatment stage may be configured to effect any desired pretreatment of the potentially impotable water from holding tank 12. It may comprise a filtration stage—an electrolytic or sand filtration stage in some embodiments.

Water-treatment system 10 includes electronic control system 24. As shown by the dashed lines of FIG. 1, the electronic control system is operatively coupled to pump 18, low-level sensor 14A, high-level sensor 16A, flow-rate sensor 20, and various other components of the water-treatment system. The electronic control system may include a microcomputer with suitable interface componentry to read one or more sensors and to actuate one or more electronically controllable components of the water-treatment system.

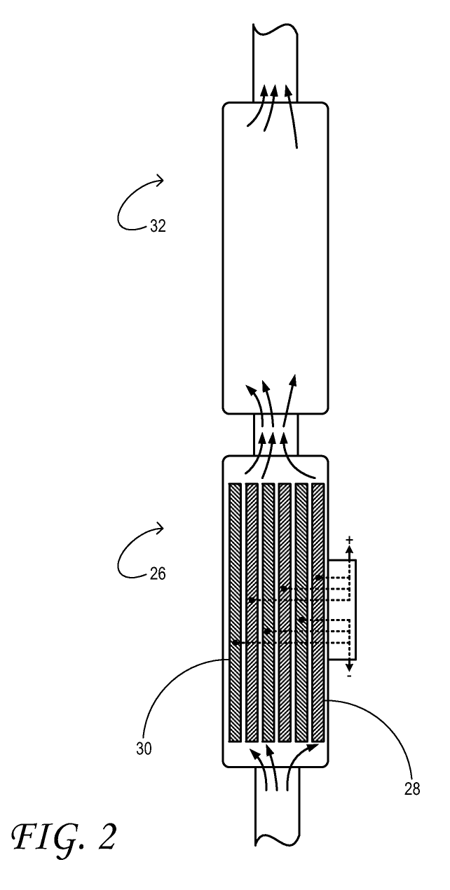

Water-treatment system 10 includes electrolysis cell 26 arranged downstream of pretreatment stage 22. An opposing pair of electrodes—anode 28 and cathode 30—are arranged inside the electrolysis cell. The illustrated embodiment provides no membrane or other isolation between the anode and the cathode. Accordingly, the flow of water admitted between these electrodes forms a continuous flow that contacts both electrodes simultaneously. The anode may be a dimensionally stable, oxidation-inert electrode. The anode may comprise bismuth with a titanium dioxide overcoat, as described in U.S. Patent Application Publication 2007/0000774. In other embodiments, the anode may comprise other metal oxides; it may be an anode manufactured by Eltech Systems Corporation (Chardon, Ohio), in one non-limiting example. The cathode may comprise stainless steel. The anode and cathode may have any suitable dimensions and any suitable orientation. In the embodiment shown in FIG. 1, the anode and cathode are planar, rectangular, and oriented parallel to each other. In a more particular embodiment, the anode and cathode may each be twelve inches long, one inch wide, and may be oriented lengthwise along the direction in which water flows through the electrolysis cell. In one embodiment, the anode and cathode may be oriented vertically and separated by a uniform gap of 0.020 to 0.080 inches. Naturally, it will be understood that the numerical values and ranges cited herein are examples only, and that other values and ranges are contemplated as well. In some embodiments, as further shown below, the electrolysis cell may comprise a plurality of anodes and/or a plurality of cathodes. The anodes and cathodes may be arranged mutually parallel to each other in an alternating sequence—e.g., anode-cathode-anode, cathode-anode-cathode-anode, etc. In one embodiment, each pair of electrodes in the sequence may be separated by a uniform gap of the same thickness. In other embodiments, pairs of electrodes may be separated by uniform gaps of different thicknesses. FIG. 2 schematically shows a more detailed view of electrolysis cell 26 and flow chamber 32 in one example embodiment.

Returning now to FIG. 1, electronic control system 10 is operatively coupled to anode 28 and cathode 30. The electronic control system is configured to bias the electrodes with respect to each other so that some of the water is electrolyzed to molecular hydrogen and molecular oxygen. Further, the electrode bias may be such that some adventitious chloride ion in the water is oxidized to chlorine and/or hypochlorous acid. The electronic control system may therefore include suitable electronic circuitry for forcing an electric current into one of the electrodes and out the other. The electronic control system may be configured to control the current using analog and/or digital feedback. In another embodiment, the electronic control system may be configured to control the potential difference applied between the electrodes or the potential applied to either or both of the electrodes. In electrolysis-cell configurations that include a plurality of cathodes and/or a plurality of anodes, the electronic control system may be operatively coupled to each anode and to each cathode.

Water-treatment system 10 includes flow chamber 32, oriented vertically, and arranged downstream of electrolysis cell 26. The flow chamber is configured to ensure contact time between the water and the gaseous electrolysis products flowing from the electrolysis cell. The flow chamber is further configured to enable an initial macro-scale separation of the water from gas bubbles entrained in the water. Such gas bubbles will comprise mostly hydrogen and oxygen, together with gasses previously dissolved in the water, such as nitrogen. In the illustrated embodiment, the flow chamber comprises a cylinder oriented vertically, with an outlet located at the top of the cylinder and an inlet at the bottom. Both the inlet and the outlet may be sized, based on the expected flow rate, for suitable mixing of gas and liquid phases, for adequate dissolution of the gasses, and for macro-scale separation.

Water-treatment system 10 includes a first gas-liquid separator 34A arranged downstream of flow chamber 32. Disposed at a high point of the water-treatment system, the first gas-liquid separator is configured to collect and separate entrained gas from the water exiting the flow chamber. As such, the first gas-liquid separator has an outlet for gas, an outlet for water, and an inlet coupled to the flow chamber. In the embodiment shown in FIG. 1, a first relief valve 36A is coupled to the gas outlet of the first gas-liquid separator. In other embodiments, the first relief valve may be integrated into the first gas-liquid separator.

Water-treatment system 10 includes discharge conduit 38 arranged downstream of first relief valve 36A. The discharge conduit provides a space into which gaseous electrolysis products are released. In one embodiment, the discharge conduit may be vented to the atmosphere. In this and other embodiments, the discharge conduit may include a catalytic convertor element configured to oxidize hydrogen to water or to steam. Such oxidation may prevent a potentially unsafe mixture of gasses from accumulating in the water-treatment system and/or downstream of the water-treatment system. In one embodiment, the heat given off from oxidation of hydrogen in the discharge conduit—an exothermic chemical reaction—may be productively utilized within the water-treatment system or elsewhere.

Water-treatment system 10 includes finisher 40 arranged downstream of the water outlet of first gas-liquid separator 34A. The finisher may be any component configured to reduce an amount of an undesired chemical species in the water—a species released by an upstream component of the water-treatment system, or, a species already present in the water supplied to the water-treatment system. In one embodiment, the finisher may comprise a deionizer. Thus, the finisher may be packed with a cationic exchange resin in a sodium phase, so that undesired cationic impurities are exchanged out of the water and are replaced by sodium ions. In another embodiment, the finisher may include a catalyst configured to destroy the undesired chemical species and to discharge only physiologically benign chemical species. For example, the catalyst may be configured to catalyze a decomposition of hydrogen peroxide into water and molecular oxygen.

In the embodiment shown in FIG. 1, water-treatment system 10 includes a second gas-liquid separator 34B and a second relief valve 36B arranged downstream of finisher 40. The gas outlet of the second gas-liquid separator, like that of the first, is coupled to discharge conduit 38. Thus, a second mode of escape is provided for gas that may have nucleated downstream of the first gas-liquid separator—e.g., within finisher 40. This second mode further prevents a potentially unsafe mixture of gasses from accumulating within and/or downstream of the water-treatment system.

Water-treatment system 10 includes outflow valve 42 and outflow tank 44. The outflow valve may be an electronically controlled portioning valve, in one embodiment. The outflow valve is operatively coupled to electronic control system 24. By controlling the outflow valve as well as the pump, the electronic control system may be configured to control the pressure of the water downstream of pump 18 at different flow-rate settings.

In the embodiment shown in FIG. 1, low-level sensor 14B and high-level sensor 16B are coupled within outflow tank 44. In other embodiments, these level sensors may be replaced by one or more pressure sensors coupled in the outflow tank or in a conduit leading to the outflow tank. One or more such sensors may respond to the amount or pressure of water available from water-treatment system 10.

Water-treatment system 10 further includes a plurality of sensors each responsive to a relative amount of a bioinhibitory agent (e.g., a biocidal, biofilm-disrupting, or biofilm-growth frustrating agent) in the water exiting the electrolysis cell. In the embodiment of FIG. 1, three such sensors are shown: dissolved-oxygen sensor 46, chlorine sensor 48, and hydrogen sensor 50. Although the sensors are shown disposed within outflow tank 44, they may instead be coupled in-line, in one or more conduits of the water-treatment system. The dissolved-oxygen sensor and the chlorine sensor are immersed below the water level in outflow tank 44, while the hydrogen sensor is positioned in the head space above the water level. Electronic control system 24 is configured to read each of the sensors. Accordingly, the electronic control system may be configured to bias the anode and cathode of the electrolysis cell in response to an output of one or more of the sensors.

The configurations described above enable various methods for sanitizing water. Accordingly, some such methods are now described, by way of example, with continued reference to above configurations. It will be understood, however, that the methods here described, and others fully within the scope of this disclosure, may be enabled via other configurations as well. The methods presented herein include various measuring and/or sensing events enacted via one or more sensors disposed in the water-treatment system. The methods also include various computation, comparison, and decision-making events, which may be enacted in an electronic control system operatively coupled to the sensors. The methods further include various hardware-actuating events, which the electronic control system may command selectively, in response to the decision-making events.

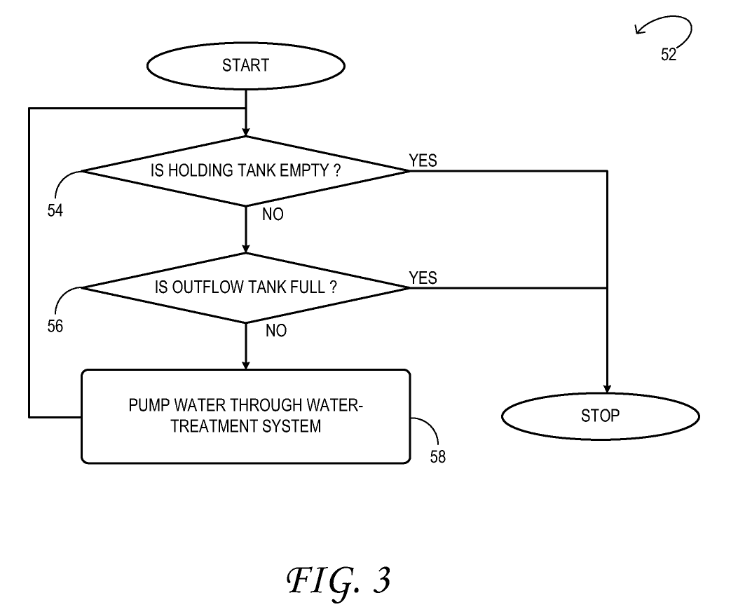

FIG. 3 illustrates an example method 52 for sanitizing water in one embodiment. At 54 it is determined whether a holding tank of a water-treatment system is empty. This determination can be made, for example, by reading a low-level sensor in the holding tank. If the holding tank is not empty, then the method advances to 56; otherwise the method stops. At 56 it is determined whether an outflow tank of the water-treatment system is full. This determination can be made, for example, by reading a high-level sensor in the outflow tank. If the outflow tank is not full, then the method advances to 58; otherwise the method stops. At 58, i.e., when the holding tank is not empty and the outflow tank is not full, water is pumped through the water-treatment system. Following 58, execution of the method resumes at 54.

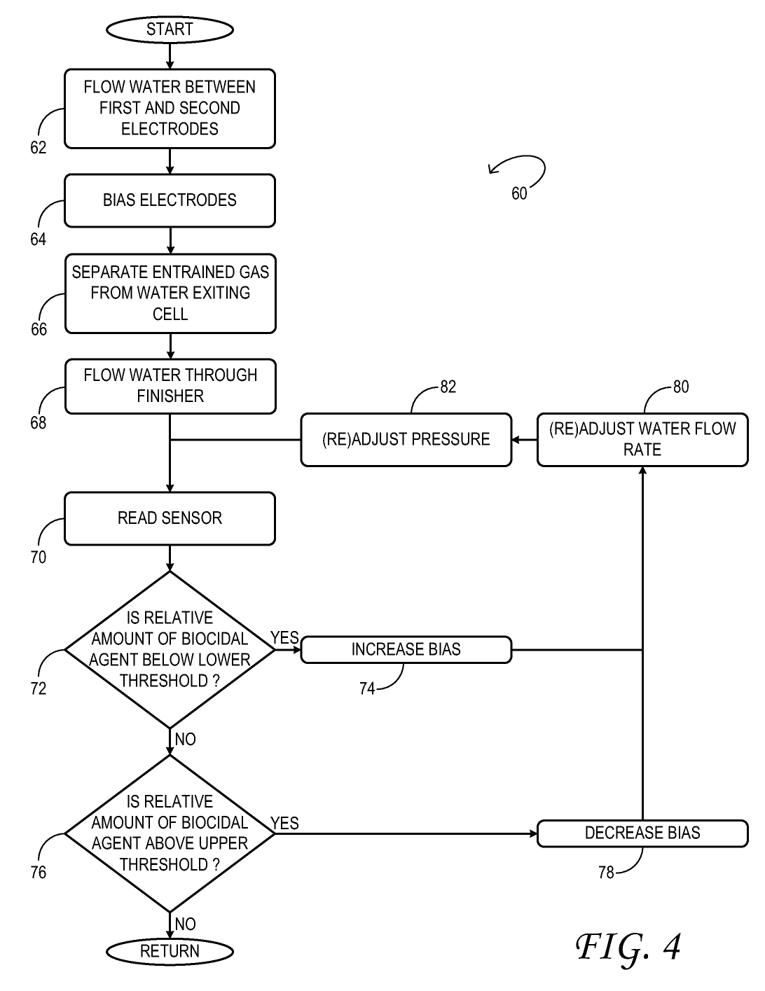

FIG. 4 illustrates another example method 60 for sanitizing water in one embodiment. The method may be enacted while water is being pumped through the water-treatment system. For instance, method 60 may be enacted at step 58 of example method 52.

At 62 potentially impotable water is flowed between first and second electrodes arranged in an electrolysis cell. In the embodiments contemplated herein, the water flows from a holding tank of a water-treatment system, where no extraneous electrolyte has been added to the water. In embodiments where no membrane or other isolation is present between the electrodes, the water forms a continuous flow that contacts both electrodes simultaneously before exiting the electrolysis cell. At 64 the electrodes are biased with respect to each other. In one embodiment, controlled current may be sunk from one of the electrodes and sourced to the other. The controlled current may be such as to provide a controlled current density at one or both of the electrodes. In one embodiment, the controlled current density may fall in the range of 10 to 200 amperes per square meter. In another embodiment, the controlled current density may fall in the range of 50 to 100 amperes per square meter, with an optimal value of 70 amperes per square meter to produce a strong bioinhibitory and/or biocidal effect. In this and other embodiments, the electrodes may be biased in response to a relative amount of a bioinhibitory agent in the water exiting the electrolysis cell, as further described below. For example, to provide the desired relative amount of the bioinhibitory agent, the current density may be decreased when the relative amount of the bioinhibitory agent increases and increased when the relative amount of the bioinhibitory agent decreases.

In other embodiments equally consistent with this disclosure, the electrodes may be biased with respect to each other by applying a controlled potential to one or both of the electrodes, or by applying a controlled potential difference therebetween. In embodiments where a controlled potential is applied, the potential may be referenced to a third electrode also coupled within the electrolysis cell.

At 66 entrained gas bubbles are separated from the water exiting the electrolysis cell, as described hereinabove. In one embodiment, the gas bubbles may be separated only after the electrolyzed gas and liquid phases have been in contact with each other for a suitable period of time—10 to 100 seconds, for example. At 68 the water exiting the electrolysis cell is further purified by flowing through a finisher. From 68 the method advances to 70.

At 70 a sensor responsive to a relative amount—i.e., a concentration or partial pressure—of a bioinhibitory agent in the water exiting the electrolysis cell is read. In one embodiment, the bioinhibitory agent may comprise one or more of molecular chlorine, hypochlorite ion, and hypochlorous acid (commonly known as residual free chlorine). These species may derive from an oxidation of substantially adventitious chloride ion in the water. In another embodiment, the bioinhibitory agent may comprise molecular oxygen. In yet another embodiment, the bioinhibitory agent may comprise molecular hydrogen. The inventor herein has observed that molecular oxygen and molecular hydrogen in combination can disrupt a biofilm and can inhibit biofilm growth in electrolyzed water.

At 72 it is determined whether the relative amount of the bioinhibitory agent is below a lower threshold. If the relative amount of the bioinhibitory agent is below the lower threshold, then the method advances to 74, where the level of bias applied between the two electrodes is increased. However, if the relative amount of the bioinhibitory agent is not below the lower threshold, then the method advances to 76. At 76 it is determined whether the relative amount of the bioinhibitory agent is above an upper threshold. If the relative amount of the bioinhibitory agent is above the upper threshold, then the method advances to 78, where the level of bias applied between the two electrodes is decreased. However, if the relative amount of bioinhibitory agent is not above upper threshold, then the method returns. In this manner, the applied bias may be adjusted in order to maintain the relative amount of the bioinhibitory agent within a desired range.

From 74 or 78, method 60 advances to 80 where the flow rate of the water is adjusted or readjusted, and to 82 where the pressure of the water is adjusted or readjusted. The flow rate of the flowing water may be adjusted in response to the relative amount of the bioinhibitory agent in the water exiting the electrolysis cell. The flow rate may be adjusted to ensure sufficient residence time for the water in the electrolysis cell, where the relative amounts of one or more bioinhibitory agents may be greatest. In another embodiment, the flow rate may be adjusted to ensure sufficient contact time between gas and liquid phases in a flow chamber of the water-treatment system. In yet another embodiment, the pressure of the flowing water may be adjusted in response to the relative amount of the bioinhibitory agent. For example, the pressure may be adjusted in order to control the relative amount of dissolved oxygen in the water exiting the electrolysis cell. Thus, the pressure of the flowing water may be increased as the relative amount of dissolved oxygen in the water exiting the electrolysis cell decreases, and decreased as the relative amount of dissolved oxygen increases.

More generally, the relative amount of any bioinhibitory agent may be controlled in a closed loop manner by reading the appropriate sensor and adjusting one or more of the electrode bias, the water flow rate, and the water pressure to keep the relative amount of the bioinhibitory agent within appropriate limits. In one embodiment, the concentration of dissolved chlorine may be maintained within 0.1 to 4 milligrams per liter, or more particularly within 0.2 to 0.8 milligrams per liter. In this and other embodiments, the concentration of dissolved oxygen may be maintained within 7.5 to 16 milligrams per liter, or more particularly within 8 to 10 milligrams per liter. In this and other embodiments, the concentration of dissolved hydrogen may be maintained within 0.1 to 1 milligrams per liter, or more particularly within 0.4 to 0.5 milligrams per liter.

It will be understood that the example control and estimation routines disclosed herein may be used with various water-treatment system configurations. These routines may represent one or more different processing strategies such as event-driven, interrupt-driven, multi-tasking, multi-threading, and the like. As such, the disclosed process steps (operations, functions, and/or acts) may represent code to be programmed into computer readable storage medium in an electronic control system.

It will be understood that some of the process steps described and/or illustrated herein may in some embodiments be omitted without departing from the scope of this disclosure. Likewise, the indicated sequence of the process steps may not always be required to achieve the intended results, but is provided for ease of illustration and description. One or more of the illustrated actions, functions, or operations may be performed repeatedly, depending on the particular strategy being used.

Finally, it will be understood that the articles, systems, and methods described hereinabove are embodiments of this disclosure—non-limiting examples for which numerous variations and extensions are contemplated as well. Accordingly, this disclosure includes all novel and non-obvious combinations and sub-combinations of the articles, water-treatment systems, and methods disclosed herein, as well as any and all equivalents thereof.

1. A method for sanitizing water, comprising:
flowing the water without added electrolyte between opposing first and second electrodes arranged in an electrolysis cell, the water forming a continuous flow that contacts both electrodes simultaneously before exiting the electrolysis cell; and
biasing the first and second electrodes with respect to each other in response to a relative amount of a bioinhibitory agent in the water exiting the electrolysis cell.

2. The method of claim 1, wherein the bioinhibitory agent comprises one or more of chlorine, hypochlorite ion, and hypochlorous acid.

3. The method of claim 2, wherein the one or more of chlorine, hypochlorite ion, and hypochlorous acid derives from an oxidation of substantially adventitious chloride ion in the water.

4. The method of claim 1, wherein the bioinhibitory agent comprises oxygen.

5. The method of claim 1, wherein the bioinhibitory agent comprises hydrogen.

6. The method of claim 1 further comprising reading a sensor responsive to the relative amount of the bioinhibitory agent in the water exiting the electrolysis cell.

7. The method of claim 1, wherein biasing the first and second electrodes with respect to each other comprises controlling a current density of the first or second electrode.

8. The method of claim 7, wherein controlling the current density comprises reducing the current density when the relative amount of the bioinhibitory agent increases and increasing the current density when the relative amount of the bioinhibitory agent decreases.

9. The method of claim 1, wherein flowing the water comprises adjusting a pressure of the flowing water, and wherein the pressure is adjusted in response to the relative amount of the bioinhibitory agent.

10. The method of claim 9, wherein adjusting the pressure of the flowing water comprises increasing the pressure as a relative amount of dissolved oxygen in the water exiting the electrolysis cell decreases, and decreasing the pressure as the relative amount of dissolved oxygen increases.

11. The method of claim 1, wherein flowing the water comprises adjusting a flow rate of the flowing water, and wherein the flow rate is adjusted in response to the relative amount of the bioinhibitory agent in the water exiting the electrolysis cell.

12. The method of claim 1 further comprising separating entrained gas bubbles from the water exiting the electrolysis cell.

13. The method of claim 1 further comprising reducing a relative amount of one or more ions in the water exiting the electrolysis cell.

14. A water-treatment system for sanitizing water, comprising:
opposing first and second electrodes arranged in an electrolysis cell and configured to admit a first flow of water therebetween, the first flow forming a continuous flow that contacts both electrodes simultaneously;
a gas-liquid separator arranged downstream of the electrolysis cell and configured to discharge a second flow of water and a third flow of gas;
a sensor responsive to a relative amount of a bioinhibitory agent in the second flow; and
an electronic control system operatively coupled to the sensor and configured to bias the first and second electrodes with respect to each other in response to an output of the sensor.

15. The water-treatment system of claim 14, wherein the first electrode is a dimensionally stable, oxidation-inert anode.

16. The water-treatment system of claim 14, wherein the first electrode comprises one or more of bismuth and titanium dioxide.

17. The water-treatment system of claim 14, wherein the second electrode is a stainless-steel cathode.

18. The water-treatment system of claim 14, wherein the first and second electrodes are separated by between 0.020 and 0.080 inches.

19. The water-treatment system of claim 14 further comprising a finisher arranged downstream of the separator and configured to reduce a relative amount of an undesired chemical species the second flow.

20. A water-treatment system for sanitizing water, comprising:
opposing first and second electrodes arranged in an electrolysis cell, separated by between 0.020 and 0.080 inches, and configured to admit a first flow of water therebetween, the first flow forming a continuous flow that contacts both electrodes simultaneously;
a gas-liquid separator arranged downstream of the electrolysis cell and configured to discharge a second flow of water and a third flow of gas;
a finisher arranged downstream of the separator and configured to reduce a relative amount of an undesired chemical species in the second flow;
a sensor responsive to a relative amount of a bioinhibitory agent in the second flow; and
an electronic control system operatively coupled to the sensor and configured to bias the first and second electrodes with respect to each other in response to an output of the sensor.
